(19) United States
(12) Patent Application Publication
(10) Pub. No.: US 2008/0059005 A1
(43) Pub. Date: Mar. 6, 2008

(54) System and method for selective on-board processing of machine data

(76) Inventors: Jonny Ray Greiner, Dunlap, IL (US); Giles Kent Sorrells, Metamora, IL (US); Richard Lee Gordon, East Peoria, IL (US); Anthony James Grichnik, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/513,525

(22) Filed: Aug. 31, 2006

(51) Int. Cl. G06F 19/00

(52) U.S. Cl. 701/1; 701/50

(57) ABSTRACT

A method for selective on-board processing of machine data includes receiving operation data associated with a machine and collecting the received operation data in an on-board processing unit of the machine. Required data associated with a data analysis task of the on-board processing unit may be identified and the received operation data may be analyzed based on the identified required data. The method may also include determining whether required data associated with the data analysis task is accessible by the on-board processing unit, based on the analysis. If any portion of the required data is inaccessible by the on-board processing unit, the inaccessible portion of the required data may be requested from an external system.

### TECHNICAL FIELD

The present disclosure relates generally to data processing systems in a machine operating environment and, more particularly, to a system and method for selective processing of data associated with a machine environment.

### BACKGROUND

Machines, such as excavators, track-type tractors, dozers, haulers, loaders, motor graders, and other types of heavy machinery, typically include equipment that collects and transmits data to an off-board computer system. The off-board system may perform a variety of data analysis tasks associated with a project environment, ranging from simple machine diagnostics to project scheduling and shift management. Each of these tasks may require a considerable amount of data from each machine operating in the project environment. As more machines are added to the project environment, the amount of data flow to the off-board system may be substantial, as each machine provides a considerable amount of information to the off-board system. As a result, costs associated with the project environment may increase, as additional network equipment and infrastructure may be required to support the need for increased bandwidth. In order to control these costs, a system for limiting the amount of information that is transmitted between the machine and the off-board system may be required.

One method for controlling information that is transmitted between a vehicle and a diagnostic service center is described in U.S. Pat. No. 6,181,994 (“the '994 patent”) to Colson et al. The '994 patent describes a diagnostic analysis system that transmits initial diagnostic information from a vehicle's on-board computer to a diagnostic center computer. In response to the transmission, the system may receive advanced diagnostic routines from the diagnostic center computer in order to further analyze the vehicle diagnostic information. As a result, diagnostic routines, which may require large amounts of storage space, are stored in a diagnostic center computer and may be provided, on request, to the vehicle.

Although the system of the '994 patent may limit the amount of information transmitted between the vehicle and the diagnostic center, in some situations it may be insufficient. For example, in order to receive the advanced diagnostic routines from the diagnostic center computer, the transmission of large amounts of initial diagnostic information may still be required.

Additionally, because the initial diagnostic information transmitted by the vehicle's on-board computer requires analysis by the diagnostic center computer to determine if additional diagnosis is required, the system of the '994 patent may be unreliable. For example, should communication between the vehicle's on-board computer and the diagnostic center computer become disabled, the vehicle may not be able to transmit and receive vital diagnostic information for long periods of time, which may ultimately result in critical damage to and, potentially, failure of one or more components of the vehicle.

The presently disclosed system and method for selective on-board processing of machine data are directed toward overcoming one or more of the problems set forth above.

### SUMMARY OF THE INVENTION

In accordance with one aspect, the present disclosure is directed toward a method for selective on-board processing of machine data. The method may include receiving operation data associated with a machine and collecting the received operation data in an on-board processing unit of the machine. Required data associated with a data analysis task of the on-board processing unit may be identified, and the received operation data may be analyzed based on the identified required data. The method may also include determining whether required data associated with the data analysis task is accessible by the on-board processing unit, based on the analysis. If any portion of the required data is inaccessible by the on-board processing unit, the inaccessible portion of the required data may be requested from an external system.

According to another aspect, the present disclosure is directed toward a method for selectively controlling the flow of data in a machine environment. The method may include receiving operation data in an on-board processing unit of the machine and determining data requirements associated with a plurality of data analysis tasks of the on-board processing unit. The data requirements associated with each of the plurality of data analysis tasks may be compared with the received operation data. Based on the comparison, one or more data requirements that are not satisfied by the received operation data may be identified. The method may also include collecting data associated with the one or more data requirements that are not satisfied by the received operation data.

In accordance with yet another aspect, the present disclosure is directed toward a system for selective processing of machine data. The system may include an on-board processing unit communicatively coupled to at least one monitoring device associated with a machine. The on-board processing unit may be configured to receive, from the at least one monitoring device, operation data associated with a machine, and store the received operation data in the at least one storage device. One or more data requirements associated with a plurality of data analysis tasks of the on-board processing unit may be identified. The on-board processing unit may be configured to analyze the received operation data with respect to the data requirements, and determine whether required data associated with the data requirements of each of the plurality of data analysis tasks is accessible by the on-board processing unit based on the analysis. If any portion of the required data is inaccessible by the on-board processing unit, the on-board processing unit may request the inaccessible portion of the required data from a project management system.

### BRIEF DESCRIPTION OF THE DRAWINGS

FIG. 1A illustrates an exemplary project environment consistent with certain disclosed embodiments;

FIG. 1B illustrates an exemplary disclosed project management system for use in the project environment of FIG. 1A consistent with certain disclosed embodiments; and

FIG. 2 illustrates a flowchart depicting an exemplary disclosed method for selective on-board processing of machine data, consistent with certain disclosed embodiments.

### DETAILED DESCRIPTION

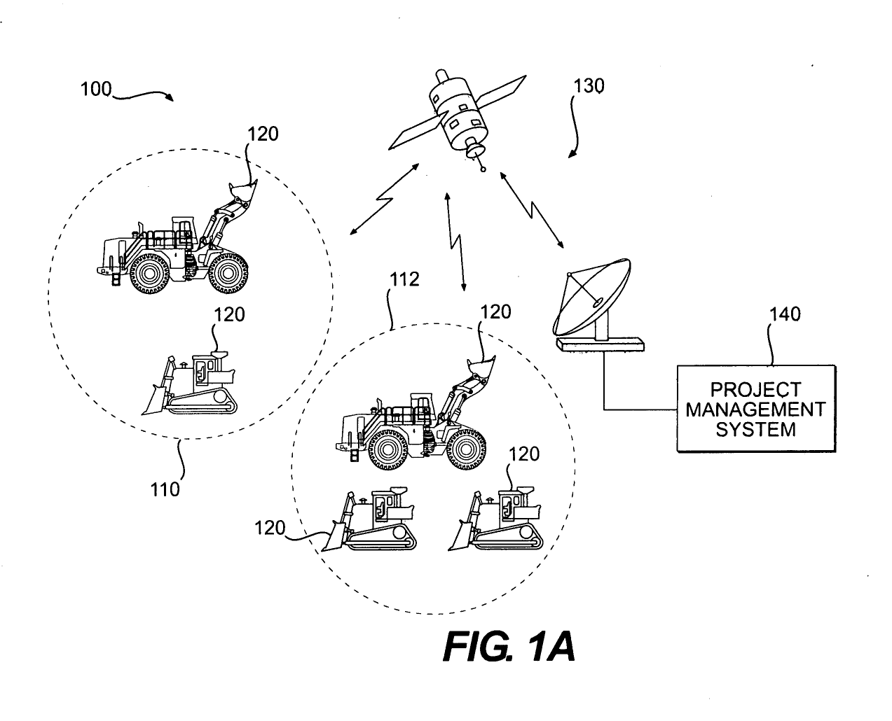

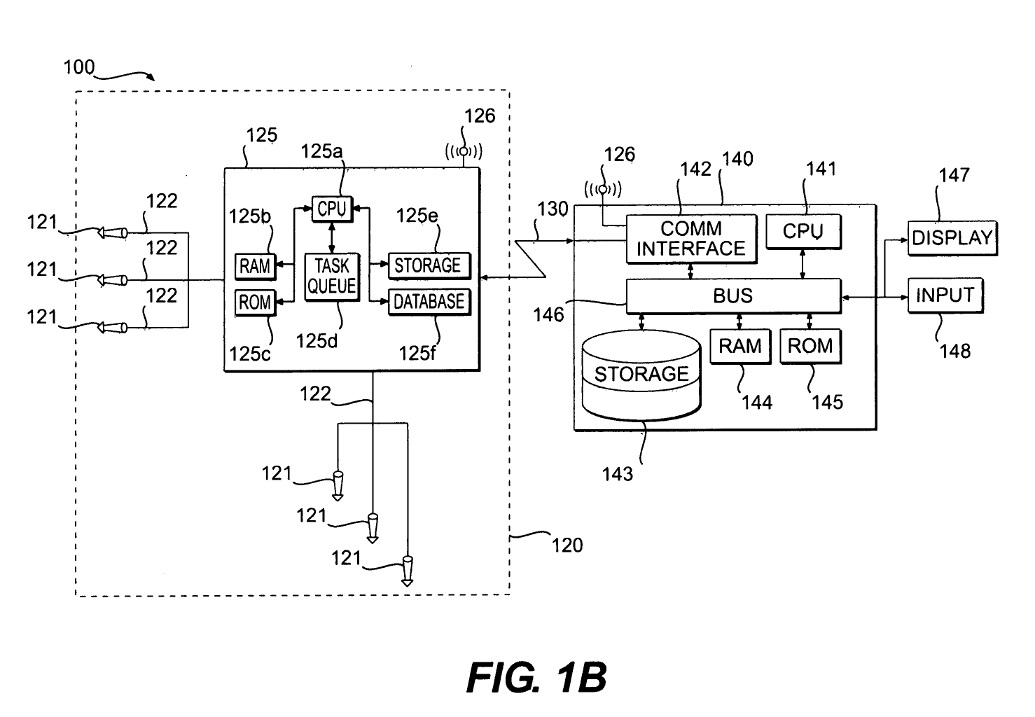

FIG. 1A illustrates an exemplary project environment 100 consistent with certain disclosed embodiments. Project environment 100 may include components that perform individual tasks that contribute to a machine environment task, such as mining, construction, transportation, agriculture, manufacturing, or any other type of task associated with other types of industries. For example, project environment 100 may include one or more machines 120 coupled to a project management system 140 via a communication network 130. The project environment 100 may be configured to monitor, collect, analyze, and filter information associated with an operation of one or more machines 120 and distribute the information to one or more back-end systems, such as project management system 140. It is contemplated that additional and/or different components than those listed above may be included in project environment 100.

Machines 120 may each be a fixed or mobile machine configured to perform an operation associated with project environment 100. Thus, machine, as the term is used herein, refers to a fixed or mobile machine that performs some type of operation associated with a particular industry, such as mining, construction, farming, etc. and operates between or within project environments (e.g., construction site, mine site, power plants, etc.) A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a project environment. A machine may be driven by a combustion engine or an electric motor. The types of machines listed above are exemplary and not intended to be limiting. It is contemplated that project environment 100 may implement any type of machine. Accordingly, although FIG. 1A illustrates machines 120 as particular types of machines, each machine 120 may be any type of machine operable to perform a particular function within project environment 100. Furthermore, it is contemplated that machines 120 may include a first set of machines 110 and a second set of machines 112 for associating the operations of particular machines 10 groups of machines. Furthermore, it is also contemplated that first and second sets of machines may be located in separate work sites located remotely from each other, and from project management system 140.

In one embodiment, each machine 120 may include on-board data collection and communication equipment to monitor, collect, and/or transmit information associated with an operation of one or more components of machine 120. As shown in FIG. 1B, machine 120 may include, among other things, one or more monitoring devices 121, such as sensors, electronic control modules (not shown), etc. coupled to one or more on-board processing units 125 via communication lines 122, one or more transceiver devices 126, and/or any other such components for monitoring, collecting, and communicating information associated with the operation of machine 120. Each machine 120 may also be configured to receive information from off-board systems, such as a project management system 140 or any other type of back-end communication system. The components described above are exemplary and not intended to be limiting. Accordingly, the disclosed embodiments contemplate each machine 120 including additional and/or different components than those listed above.

On-board processing unit 125 may include various hardware and/or software components that perform processes consistent with certain disclosed embodiments. For example, processing unit 125 may include one or more central processing units (CPU) (125a) for processing and analyzing parameter data, one or more computer-readable memory devices (such as RAM 125b, ROM 125c, and on-board storage 125e) for storing parameter data, and an on-board database 125f for storing, filtering, and sorting data stored in on-board processing unit 125. It is contemplated that on-board processing unit 125 may include one or more executable programs that, when executed by the CPU, may further analyze parameter data collected from monitoring devices 121 and/or an external system, such as project management system 140. It is also contemplated that on-board processing unit 125 may include a task queue 125d for storing and prioritizing certain data analysis tasks and functions performed by on-board processing unit 125. Task queue 125d may also monitor the data requirements and provide a status of each task associated with task queue 125d. Once a particular task has been completed, task queue 125d may be updated to remove the completed task from the task queue. Data analysis tasks will be described in greater detail below.

On-board processing unit 125 may be operable to collect operational information associated with machine 120 and perform one or more data analysis tasks associated with machine 120. For example, on-board processing unit 125 may collect operational information associated with an operation of machine 120 during the execution of an assigned task (i.e., in “real-time”). On-board processing unit 125 may analyze the received operational information with respect to one or more data requirements associated with any programmed analysis tasks performable by on-board processing unit 125. Data analysis tasks, as the term is used herein, may refer to any type of functional analysis task associated with operations of machine 120 such as, for example, machine and/or component diagnostics (i.e., monitoring of parameters, such as engine temperature, tire pressure, fuel economy, etc.); machine registration and validation; task management (e.g., task scheduling, productivity reporting, etc); operator performance analysis; or any other type of task associated with the analysis of machine operation data.

Each data analysis task may include one or more data requirements. Data requirement, as the term is used herein, refers to any portion of data that may be required prior to the performance of a data analysis task. For example, a particular data analysis task may include analyzing an engine coolant temperature associated with machine 120 with respect to a predetermined coolant threshold. This particular task may depend upon temperature data associated with one or more coolant temperature sensors associated with machine 120. Thus, at least one data requirement associated with this data analysis task includes temperature data received from one or more of the coolant temperature sensors.

As noted in the example above, certain data analysis tasks may depend on data collected by monitoring devices 121. For instance, an engine monitoring and reporting task may only require measurements associated with the engine or engine components. However, it is contemplated that certain data analysis tasks may include one or more data requirements that rely on external data (i.e., data that may not be available to and/or accessible by on-board processing unit 125). For example, certain data analysis tasks, such as project scheduling, may be based on operational aspects external to machine 120 such as position data associated with one or more machines cooperating to perform a particular task, productivity data associated with one or more other machines, weather conditions associated with project environment 100, or any other type of data that may not be accessible by on-board processing unit 125. On-board processing unit 125 may be configured to identify whether the data required by each analysis task is available and/or accessible. On-board processing unit 125 may also be configured to distribute the operation data to project management system 140 via communication network 130.

According to one embodiment, on-board processing unit 125 may include one or more components configured to perform a data analysis task that includes analyzing operational information from machines 120 with respect to predefined specifications stored in a storage device accessible by on-board processing unit 125. For example, on-board processing unit 125 may be configured with on-board logic circuitry that analyzes operation data received from machine 120. Predefined specifications include one or more data indicative of an appropriate operation of a particular machine, type of machine, or its constituent components. For example, predefined design specifications may include, for example, benchmark operational ranges, stress-strain thresholds, mechanical force limits, fuel economy, temperature ranges, pressure ranges, load limits, or any other such predefined specification benchmarking the performance of a machine during normal operations. Moreover, each of the predefined specifications may be associated with one or more components of machine 120 such as, for example, a combustion engine, a motor, a transmission, a fluid cooling system, a generator, a cooling tank, a lubricating fluid, or any other component of machine 120.

According to this embodiment, on-board processing unit 125 may also be configured to compare the received operation data from machine 120 to one or more predefined specifications and determine whether the received operation data indicates that machine 120 is operating within a predetermined range. For example, on-board processing unit 125 may receive operation data from, among other things, an electric motor of machine 120. The operation data may include data indicative of a field current through a stator winding of the motor. On-board processing unit 125 may compare the received field current data to predefined design specifications related to the field current of the motor to determine whether the received field current (i.e., actual field current during motor operation) conforms to the design tolerances associated with the predefined design specifications. Although this example illustrates the received operation data as being associated with one component, it is contemplated that received operation data may include any data indicative of an operation of machine 120 or any of its constituent components. Furthermore, on-board processing unit 125 may be configured to analyze operation data associated with any number of components of machine 120, and may perform analyses of these components in series, parallel, simultaneously, sequentially, or any combination thereof.

Communication network 130 may include any network that provides two-way communication between each machine 120 and an off-board system, such as project management system 140. For example, communication network 130 may communicatively couple machines 120 to project management system 140 across a wireless networking platform such as, for example, a satellite communication system. Alternatively and/or additionally, communication network 130 may include one or more broadband communication platforms appropriate for communicatively coupling one or more machines 120 to project management system 140 such as, for example, cellular, Bluetooth, microwave, point-to-point wireless, point-to-multipoint wireless, multipoint-to-multipoint wireless, or any other appropriate communication platform for networking a number of components. Although communication network 130 is illustrated as a satellite-based wireless communication network, it is contemplated that communication network 130 may include wireline networks such as, for example, Ethernet, fiber optic, waveguide, or any other type of wired communication network.

Project management system 140 may include any computing system configured to receive, analyze, and distribute operational data received from one or more machines 120 via communication network 130. For purposes of this disclosure, operation data may include operational and/or productivity information indicative of one or more parameters associated with the operation of a particular machine 120. For example, operational information may include status data (e.g., engine on/off, parked, stationary, etc.), load weight, engine speed, engine temperature, oil pressure, location, GPS coordinates, engine hours, tire wear, component fatigue, fluid levels, pressure data, machine position information, and any other parameter associated with the operation of a machine. Productivity information may include information indicative of the productivity of machine 120 such as, for example, an amount of material moved, how quickly the machine was able to complete a particular task associated with project environment 100, an amount of energy expended by machine 120 during operations within project environment 100, an efficiency in completing an assigned task, or any other suitable indicator of machine productivity.

Project management system 140 may include a diagnostic system associated with project environment 100. For example, project management system 100 may be configured to analyze operational and/or productivity data associated with one or more machines associated with project environment 100 to determine the status and/or analyze the performance of a machine or machine component. Project management system 140 may also collect and distribute required data associated with a data analysis task of on-board processing unit 120. Project management system 140 may also communicate with other systems (e.g., one or more other computer systems (not shown), one or more business risk assessment systems (not shown), one or more information storage databases (not shown), one or more site-managers (not shown), etc.).

In one embodiment, project management system 140 may include hardware and/or software components that perform processes consistent with certain disclosed embodiments. For example, as illustrated in FIG. 1B, project management system 140 may include one or more transceiver devices 126, a central processor unit (CPU) 141, a communication interface 142, one or more computer-readable memory devices, including storage device 143, a random access memory (RAM) module 144, and a read-only memory (ROM) module 145, a display device 147, and/or an input device 148. The components described above are exemplary and not intended to be limiting. Furthermore, it is contemplated that project management system 140 may include alternative and/or additional components than those listed such as, for example, one or more software programs including instructions for executing process steps when executed by CPU 141.

CPU 141 may include one or more processors that execute instructions and process data to perform one or more processes consistent with certain disclosed embodiments. For instance, CPU 141 may execute software that enables project management system 140 to request and/or receive operation data from on-board processing unit 125 associated with machine 120. CPU 141 may also execute software that stores collected operation data in storage device 143. In addition, CPU 141 may execute software that enables project management system 140 to analyze operation data collected from one or more machines 120, modify one or more project specifications of the project environment 100, and/or provide customized project status reports, including recommendations for modifications to project specifications and/or operational instructions for executing the project. A project specification may include one or more characteristics associated with the execution of a machine project such as, for example, a project schedule for completion of the machine project, a productivity schedule for each respective machine operating in project environment 100, a project productivity rate (e.g., percentage of project completed per month), a project budget, a productivity quota for machine 120, maintenance schedules, hours of operation for the machine and/or job-site, an assignment for a particular machine, a job-site inventory, and any other type of characteristic associated with project management. Furthermore, a project specification may include a guideline that, when used as a project benchmark, may assist in the appropriate execution of a project performed within project environment 100. These benchmarks may include incremental completion milestones, budget forecasts, and any other type of performance and/or operation benchmark.

CPU 141 may be connected to a common information bus 146 that may be configured to provide a communication medium between one or more components associated with project management system 140. For example, common information bus 146 may include one or more components for communicating information to a plurality of devices. CPU 141 may execute sequences of computer program instructions stored in computer-readable medium devices such as, for example, a storage device 143, RAM 144, and/or ROM 145 to perform methods consistent with certain disclosed embodiments, as will be described below.

Communication interface 142 may include one or more elements configured for communicating data between project management system 140 and one or more on-board processing units 125 via transceiver device 126 over communication network 130. For example, communication interface 142 may include one or more modulators, demodulators, multiplexers, demultiplexers, network communication devices, wireless devices, antennas, modems, and any other type of device configured to provide data communication between project management system 140 and remote systems or components.

One or more computer-readable medium devices may include one or more storage devices 143, a RAM 144, ROM 145, and/or any other magnetic, electronic, or optical data computer-readable medium devices configured to store information, instructions, and/or program code used by CPU 141 of project management system 140. Storage devices 143 may include magnetic hard-drives, optical disc drives, floppy drives, or any other such information storing device. A random access memory (RAM) device 144 may include any dynamic storage device for storing information and instructions by CPU 141. RAM 144 also may be used for storing temporary variables or other intermediate information during execution of instructions to be executed by CPU 141. During operation, some or all portions of an operating system (not shown) may be loaded into RAM 144. In addition, a read only memory (ROM) device 145 may include any static storage device for storing information and instructions by CPU 141.

Project management system 140 may include one or more input devices configured to receive one or more project specifications (e.g., project schedule, job-site inventory, project budget, individual machine tasks, etc.) indicative of a project to be performed by a plurality of machines from one or more users associated with project environment 100. For example, project management system may include a console with integrated keyboard and mouse to allow a user of project management system (e.g., customer, client, etc.) to input project specifications corresponding to a particular project to be performed as part of project environment 100. Project management system 140 may store the project specifications in storage device 143 for future analysis and/or modification. The components listed above are exemplary only and not intended to be limiting. Accordingly, additional, fewer, and/or different input devices may included with project management system 140.

Project management system 140 may be coupled to on-board data collection and communication equipment to monitor, collect, and/or transmit information associated with an operation of one or more components of machine 120. In one embodiment, project management system 140 may be coupled to one or more on-board processing units 125 on respective machines 120 via transceiver device 126 to collect operation data from one or more monitoring devices 121, such as sensors, electronic control modules, etc. (not shown), and/or any other such components for monitoring, collecting, and communicating-information associated with the operation of a respective machine 120. Project management system 140 may also be configured to transmit information to machine 120 via communication network 130.

Project management system 140 may also include other components that perform functions consistent with certain disclosed embodiments. For instance, project management system 140 may include a memory device configured to store, among other things, one or more software applications including, for example, a database program, a graphical user interface, data acquisition and analysis software, or any other appropriate software applications for operating and/or monitoring project environment 100.

In certain embodiments, project management system 140 may modify a project specification associated with project environment 100 based on the status of one or more machines 120. For example, project management system 140 may modify a project specification to compensate for any machines that have been incapacitated or taken off-line for service. Alternatively and/or additionally, project management system 140 may modify one or more additional and/or different project specifications associated with other machines operating within the same work site to reflect a respective change associated with project environment 100.

Processes and methods consistent with the disclosed embodiments may provide a system that limits the amount of bandwidth required for machine diagnostics and monitoring, by performing as many of these functions in an on-board processing unit associated with the machine. By limiting the automatic transfer of monitored data to an external processing tool to only the data that may not be available to and/or accessible by the on-board processing unit, a significant amount of bandwidth may be freed up for more critical tasks.

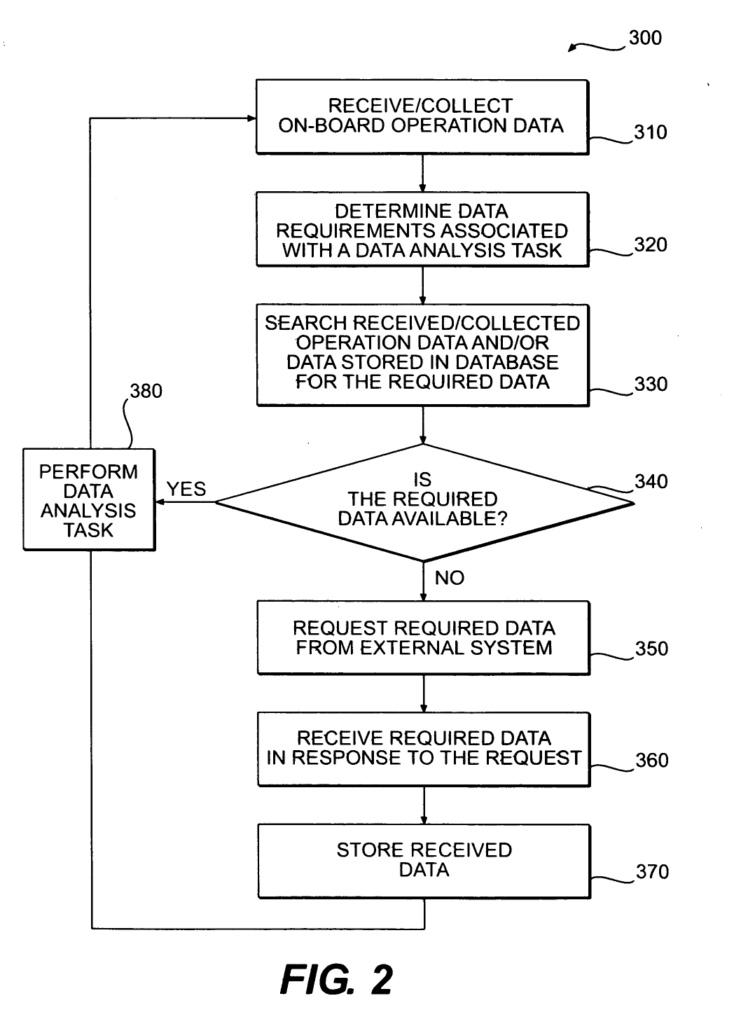

FIG. 2 provides a flowchart 300 illustrating an exemplary disclosed method for selective processing of machine data, consistent with certain disclosed embodiments. As illustrated in FIG. 2, machine operation data collected one or more monitoring devices 121 by may be received by on-board processing unit 125 associated with machine 120 (Step 310). For example, on-board processing unit 125 may automatically receive operation data during “real-time” operations of machine 120. Alternatively and/or additionally, on-board processing unit 125 may periodically collect operation data from each of monitoring devices 121, during operations of machine 120.

Once the operation data has been received, the data requirements associated with each data analysis task assigned to on-board processing unit 125 may be identified (Step 320). For instance, on-board processing unit 125 may analyze every assigned task stored in a task queue of on-board processing unit 125. Each data requirement associated with the assigned task may be identified and flagged. In an alternate embodiment, the data requirements may be predetermined for each task and stored in a on-board storage device (not shown) accessible by on-board processing unit 125.

Upon identifying and flagging each data requirement associated with a data analysis task, on-board processing unit 125 may search the received operation data (as well as any other data stored in on-board memory) for the required data associated with each data requirement (Step 330). For example, on-board processing unit 125 may compare the received data with each data requirement to determine if the data requirement is satisfied by any part of the received data. Alternatively and/or additionally, on-board processing unit 125 may search one or more on-board storage devices for data that satisfies the data requirements. If the required data includes one or more of the received data or the stored data, the flag associated with data requirement may be cleared. Any data requirements that are not satisfied by the received data or the stored data may retain their flag.

Once the received and stored data has been searched, each data requirement may be analyzed by on-board processing unit 125. Any data analysis tasks associated with data requirements that do not have flags (indicating that the required data is accessible to on-board processing unit 125 (Step 340: Yes)) may be performed by on-board processing system 125 (Step 380). Alternatively, any required data associated with data requirements that have been flagged (indicating that the data required to satisfy the data requirement is not accessible to on-board processing unit (Step 340: No)) may be requested by on-board processing unit (Step 350). This request may be transmitted to an off-board (i.e., external) system, such as project management system 140.

According to one embodiment, upon receiving a data request from on-board processing unit 125, project management system 140 may search for the requested data. For example, project management system 140 may maintain one or more databases that contain volumes of data associated with project environment 100. Accordingly, project management system 140 may search the database to locate the requested data. Alternatively and/or additionally, project management system 140 may search for the information on one or more other computer systems that may be associated with communication network 130. Additionally, project management system 140 may search for the requested data using one or more external networks, such as the Internet, etc. Once the requested data has been collected, project management system 140 may transmit the collected data to on-board processing unit 125 in response to the data request.

On-board processing system 125 may receive the requested data from project management system 140 (Step 360). Once the required data has been received, on-board processing unit 125 may store the data in on-board memory (e.g., database, storage, etc.) (Step 370), and compare the received data with the data requirements that have flags remaining, to ensure that the received data satisfies the flagged data requirements. If any of the previously-flagged data requirements associated with a data analysis task has been appropriately satisfied by the received data, on-board processing unit 125 may clear the flag(s) and perform the data analysis task (Step 380).

### INDUSTRIAL APPLICABILITY

Although methods and systems associated with the disclosed embodiments are described in relation to machines 120 and machine environment 100, they may be applicable to any environment where it may be advantageous to conserve bandwidth by selectively processing data in an on-board system and communicating only certain portions of required data that may be inaccessible to the on-board system. According to one embodiment, the disclosed system and method for selective on-board processing of machine data may provide more robust on-board processing capabilities for machines 120, while reserving bandwidth associated with project environment communication systems for more important processing tasks. This may reduce the congestion associated with the communication of large amounts of raw data between one or more machines 120 and project management system 140.

The presently disclosed system and method for selective on-board processing of machine data may have several advantages. First, much of the routine monitoring and diagnostic capabilities are performed in an on-board processing unit associated with each machine. Selectively performing analysis tasks in this way may reduce data congestions on project management system 140, enabling it to perform more important tasks associated with project environment 100, such as project management, shift scheduling, production management, etc., potentially resulting in more efficient execution of project tasks.

Additionally, the presently disclosed selective on-board processing system may have certain cost advantages. For example, because more information is processed in on-board processing unit 125 of each machine, which limits the amount of data processed by and, therefore, transferred to off-board systems (such as project management system 140), less bandwidth may be consumed communicating raw machine data between machines 120 and the off-board system. This may reduce the data congestion on communication network 130, freeing up bandwidth and allowing more machines to be to be added to communication network 130 without requiring additional network equipment and/or infrastructure. As a result, by implementing the presently disclosed selective on-board processing system and associated methods, the need for costly network upgrades may be reduced and/or eliminated.

It will be apparent to those skilled in the art that various modifications and variations can be made to the disclosed system and method for selective on-board processing of machine data. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for selective on-board processing of machine data, comprising:
receiving operation data associated with a machine;
collecting the received operation data in an on-board processing unit of the machine;
identifying required data associated with a data analysis task of the on-board processing unit;
analyzing the received operation data based on the identified required data;
determining whether required data associated with the data analysis task is accessible by the on-board processing unit, based on the analysis; and
requesting, if any portion of the required data is inaccessible by the on-board processing unit, an inaccessible portion of the required data from an external system.

2. The method of claim 1, further including:
receiving the requested portions of the required data from the external system; and
storing the data received from the external system in an on-board database associated with the on-board processing unit.

3. The method of claim 2, further including performing the data analysis task in response to receiving the requested portion of the required data from the external system.

4. The method of claim 1, wherein determining whether the required data is accessible includes one or more of:
searching the received data indicative of operations associated with the machine; and
searching data stored in an on-board database associated with the on-board processing unit.

5. The method of claim 4, further including performing the data analysis task of the on-board processing unit if every portion of the required data is accessible by the on-board processing unit.

6. The method of claim 5, wherein the external system includes a project management system and the data analysis task includes a validation process whereby certain operations of the machine are authorized by the project management system.

7. The method of claim 5, wherein the external system includes a project management system and the data analysis task includes a validation process, whereby the machine is registered to a particular geographical area by the project management system.

8. The method of claim 5, wherein the data analysis task includes a production schedule, whereby tasks associated with the machine are scheduled based on operation data associated with one or more other machines operating within a particular job-site.

9. The method of claim 1, wherein the receiving includes periodically collecting operation data from one or more sensing devices associated with the machine.

10. A computer-readable medium for use on a computer system, the computer-readable medium having computer-executable instructions for performing the method of claim 1.

11. A method for selectively controlling the flow of data in a machine environment, comprising:
receiving operation data in an on-board processing unit of a machine:
determining data requirements associated with a plurality of data analysis tasks of the on-board processing unit;
comparing the data requirements associated with each of the plurality of data analysis tasks with the received operation data;
identifying, based on the comparison, one or more data requirements that are not satisfied by the received operation data; and
collecting data associated with the one or more data requirements that are not satisfied by the received operation data.

12. The method of claim 11, wherein the collecting includes providing, to an external system, a request for the data associated with the one or more data requirements that are not satisfied by the received operation data.

13. The method of claim 11, wherein the collecting includes:
locating, by an external system, the data associated with one or more data requirements that are not satisfied by the received operation data; and
transmitting the located data to the on-board processing unit of the machine.

14. The method of claim 13, further including performing one or more of the data analysis tasks of the on-board processing unit if each data requirement corresponding to the one or more data analysis tasks have been satisfied.

15. A system for selective processing of machine data, comprising:
an on-board processing unit communicatively coupled to at least one monitoring device associated with a machine, the on-board processing unit configured to:
receive, from the at least one monitoring device, operation data associated with a machine;
store the received operation data in the at least one on-board storage device;
identify data requirements associated with a plurality of data analysis tasks of the on-board processing unit;
analyze the received operation data with respect to the data requirements;
determine whether required data associated with the data requirements of each of the plurality of data analysis tasks is accessible by the on-board processing unit, based on the analysis; and
request, if any portion of the required data is inaccessible by the on-board processing unit, the inaccessible portion of the required data from a project management system.

16. The system of claim 15, wherein the on-board processing unit includes an electronic control unit associated with the machine.

17. The system of claim 15, wherein the project management system is communicatively coupled the on-board processing unit and configured to:
locate data requested by the on-board processing unit, in response to the request; and
provide the requested data to the on-board processing unit.

18. The system of claim 15, wherein the on-board processing unit is further configured to perform one or more of the data analysis tasks of the on-board processing unit if the required data associated with a respective one or more data analysis tasks is accessible by the on-board processing unit.

19. The system of claim 15, wherein the on-board processing unit is further configured store, in a task queue, any data analysis task having data requirements that include the inaccessible portion of the required data.

20. The system of claim 19, wherein the on-board processing unit is further configured to:
receive the inaccessible portion of the required data from the project management system; and
perform one or more data analysis tasks stored in the task queue, in response to the receipt of the inaccessible portion of the required data.
